(19) United States
(12) Patent Application Publication
(10) Pub. No.: US 2014/0053790 A1
(43) Pub. Date: Feb. 27, 2014

(54) All-in-one Pet Garment

(71) Applicant: Mystique Rumps, Rolling Meadows, IL (US)

(72) Inventor: Mystique Rumps, Rolling Meadows, IL (US)

(21) Appl. No.: 13/768,722

(22) Filed: Feb. 15, 2013

Related U.S. Application Data
(60) Provisional application No. 61/633,795, filed on Feb. 17, 2012.

(51) Int. Cl. A01K 13/00

(52) U.S. Cl. CPC A01K 13/006
USPC 119/850

(57) ABSTRACT

An integrated pet outfit that combines pet clothing with pet shoes and provides protection against inclement weather and outdoor elements as well as reducing the transmission of dirt and grime from outdoors into the owners home. The integration of the body covering, leggings and shoes minimizes exposure to the elements and prevents the loss or accidental removal of individual shoes.

### CROSS-REFERENCE TO RELATED APPLICATIONS

This is a nonprovisional of a provisional application, Ser. No. 61/633,795 filed on Feb. 17, 2012, whose entire disclosure is incorporated by reference in its entirety herein.

### BACKGROUND OF THE INVENTION

1. Field of the Invention

The present invention relates generally to pet clothing and protective wear or apparel. In particular, it provides articles of clothing specifically designed to protect dogs from outside elements and to prevent the transmission of dirt and grime from outside into the pet owner's home.

2. Background

When nature calls, taking the pet for a walk is no longer desirable unless the owner would like to clean up inside their home. Unfortunately, the weather does not always cooperate with providing the perfect conditions for walking your pet and finding the perfect spot for waste elimination. Dogs seem to have an innate ability to find ways to get dirty, ensuring that when returning home after a romp in the park, the owner must face the issues of tracking the outside elements back into the house, or bathing the dog immediately to remove the outside elements. This is especially true during the rainy and snowy days or other whether conditions when it is inappropriate for leaving the pet outside of the house after the walk. Moreover, for pets that are kept in the living quarters with the owner, pet owners always try to avoid having outside elements, not to mention bugs or insects, into the living quarters. Prior pet clothes or apparels generally provide mere covering for the torso of the animal, but do not adequately address the need for overall body covering, or integrating the body coverings and paw coverings. In addition, previous variations of pet clothing include mainly with separate pieces for the body and for the paws. Since the shoes/booties are separate, they may be easier for the pet to remove and can become lost or dislodged, making it difficult for the pet to walk and becomes an added expense for the pet owner to replace.

In another example, U.S. Pat. No. 6,024,055 discloses a dog sweater with integral legs, is constructed of knit materials and has a traditional circular neck band like a sweater requiring it to be pulled over the dogs head both to put it on and take it off. In a further example, U.S. Pat. No. 6,223,696 is constructed to provide ease of movement for the pet while walking and exercising but provides scant coverage of the body and no coverage of the legs and paws.

### SUMMARY

Embodiments of the invention overcome shortcomings of the prior technology by providing integrated pet apparel with paw-to-paw coverings for a pet.

A pet apparel apparatus includes a torso element for receiving a torso of an animal. The apparatus also includes an opening for receiving a head of the animal. The apparatus further includes a set of leggings, and the set of leggings includes materials for receiving legs of the animal and for receiving paws of the animal. The apparatus includes a set of attachments disposed on the torso element, and the set of attachments has a male portion and a female portion. The male portion corresponds to the female portion. The set of attachments encloses the animal therein. The apparatus has another opening for receiving a rear of the animal.

Another embodiment of the pet apparel apparatus includes a hood disposed at the opening for covering the head of the animal.

Another embodiment of the pet apparel apparatus includes a set of fasteners disposed on the torso element, and the set of fasteners has a male portion and a female portion. The male portion corresponds to the female portion. The set of fasteners encloses the animal therein;

Another embodiment of the pet apparel apparatus includes the torso element, the set of leggings, and the set of attachments connected as an integrated piece.

### BRIEF DESCRIPTION OF THE DRAWINGS

The present invention will now be discussed in further detail below with reference to the accompanying figures in which:

FIG. 1 is an illustration of a bottom view of a pet apparel according to one embodiment of the invention.

FIG. 2 is an illustration of a perspective view of the pet apparel in FIG. 1 according to one embodiment of the invention.

FIG. 3 is an illustration of a bottom view of a pet apparel according to another embodiment of the invention.

FIG. 4 is an illustration of a bottom view of a pet apparel according to a further embodiment of the invention.

FIG. 5 is an illustration of a bottom view of a pet apparel according to an alterative embodiment of the invention.

FIG. 6 is an illustration of a perspective view of the pet apparel in FIG. 5 according to the alternative embodiment of the invention.

### DETAILED DESCRIPTION

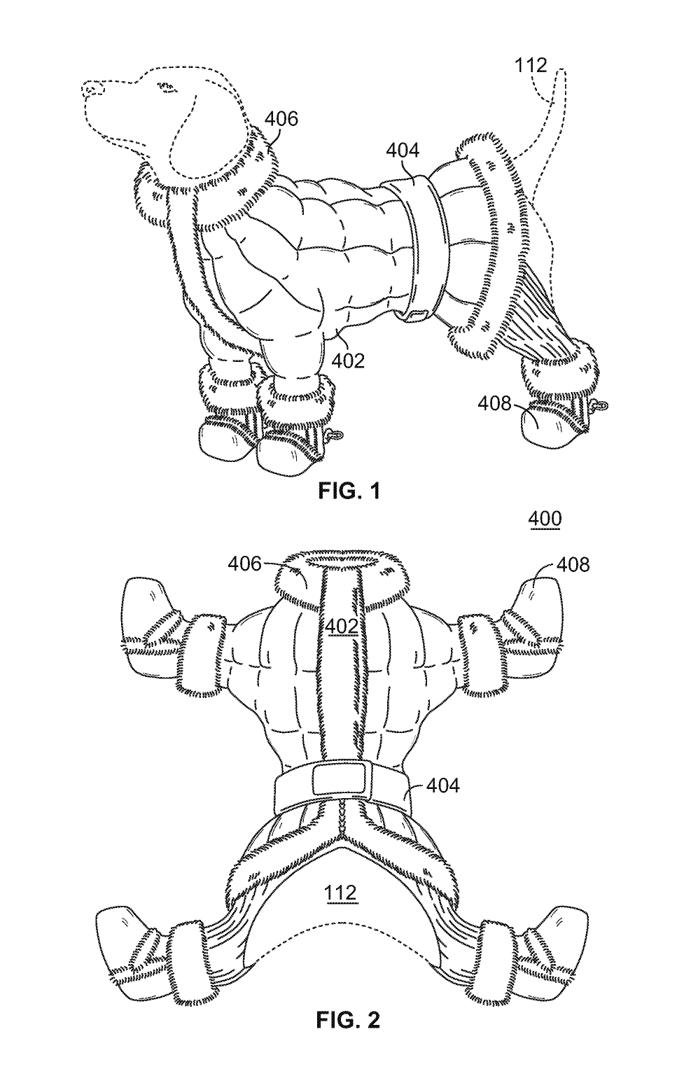

FIG. 1 illustrates a bottom view of a pet apparel 100 according to an embodiment of the invention. For example, the pet apparel 100 includes a torso element or main garment 102, a set of leggings 108. For example, the torso element 102 includes materials or fabrics that are used to receive, cover, or protect the torso of an animal 112. In another embodiment, the torso element 102 includes an opening for receiving the head of the animal 112. In a further embodiment, the torso element 102 includes another opening for the rear of the animal 112. For example, the another opening includes an opening for one or more of the following parts of the animal 112: croup, tail, rump, hip, and flank. In one example, the animal 112 is a dog or canine It is to be understood that the animal 112 may be other animals for which the apparel 100 is suited.

In one embodiment, the set of leggings 108 is four to receive limbs of the animal 112. For example, the set of leggings 108 are made of materials with sufficient length and width to receive or accommodate the limbs and the paws or claws of each of the limbs therewith such that the majority of the limbs and paws are covered by the materials of the set of leggings 108. In one embodiment, the set of leggings 108 receives or covers the entire limbs and paws. In another embodiment, the set of leggings 108 receives or covers the front limbs or legs of the animal 112 in its entirety while receiving or covering a majority of the hind limbs or legs of the animal 112.

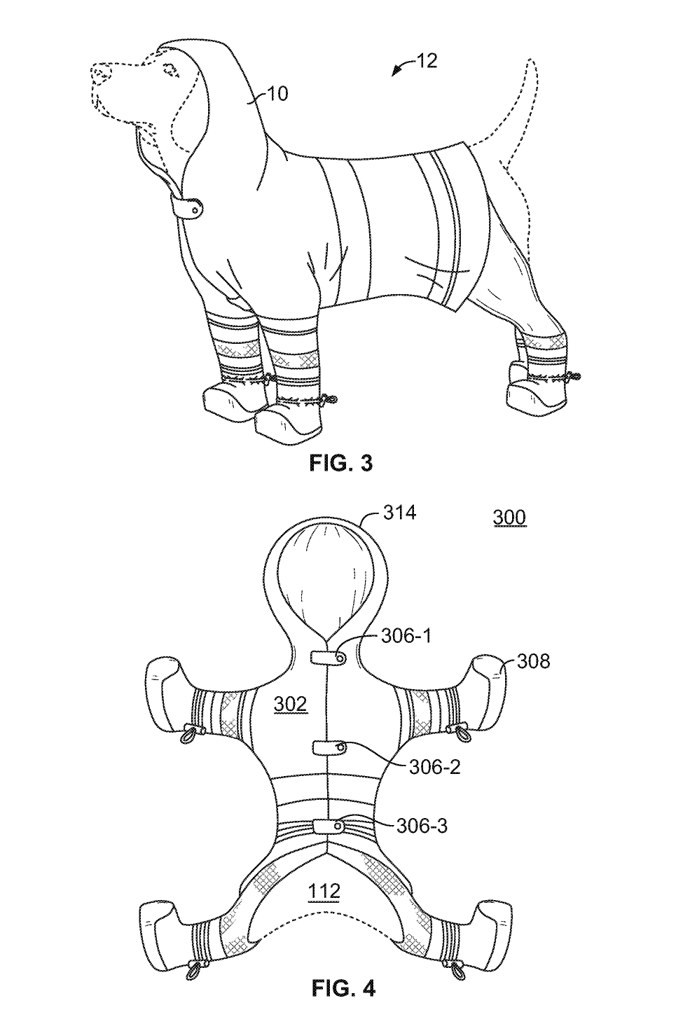

Referring further to FIG. 1, the apparel 100 also includes a set of attachments 106 or 104. The set of attachments 106 or 104 may be disposed on different locations on the torso element 102. For example, the set of attachments 106 may be disposed near the opening of the apparel 100 to enclose the torso element 102 to the torso of the animal 112 near the neck area. In another example, the set of attachments 104 may be disposed near the abdomen or mid-section of the animal 112 to tighten the torso element 102. In one example, the set of attachments 106 or 104 may be fasteners of different types, such as Velcro, buttons, latches, belts, zippers, hook and loop type fastener, a hook and loop fastener, and snaps may also be used. For example, referring to FIG. 3, a zipper 206 for a pet apparel 200 is used as the set of attachments or fasteners for a torso element 202. As such, the pet apparel 200 with its set of leggings 208 may be used to accommodate a particular size of animals 112 where the zipper 206 is more suitable. Moreover, a V-shaped opening 310 enables for freedom of movement of the animal 112 and expulsion of bodily waste of the animal 112. A drawstring and clamp 212 enables the set of leggings 208 to be tightened around the lower part of the leg and secure the paws or claws of the animal 112.

In a further example, referring to FIG. 4, a set of button combinations 306 (306-1, 306-2, and 306-3) is disposed on three locations of a torso element 302 for a pet apparel 300. In this example, the pet apparel 300 and its set of leggings 308 may be tailored toward another set of animals 112 where multiple attachments or fasteners for the torso element 302 are preferable.

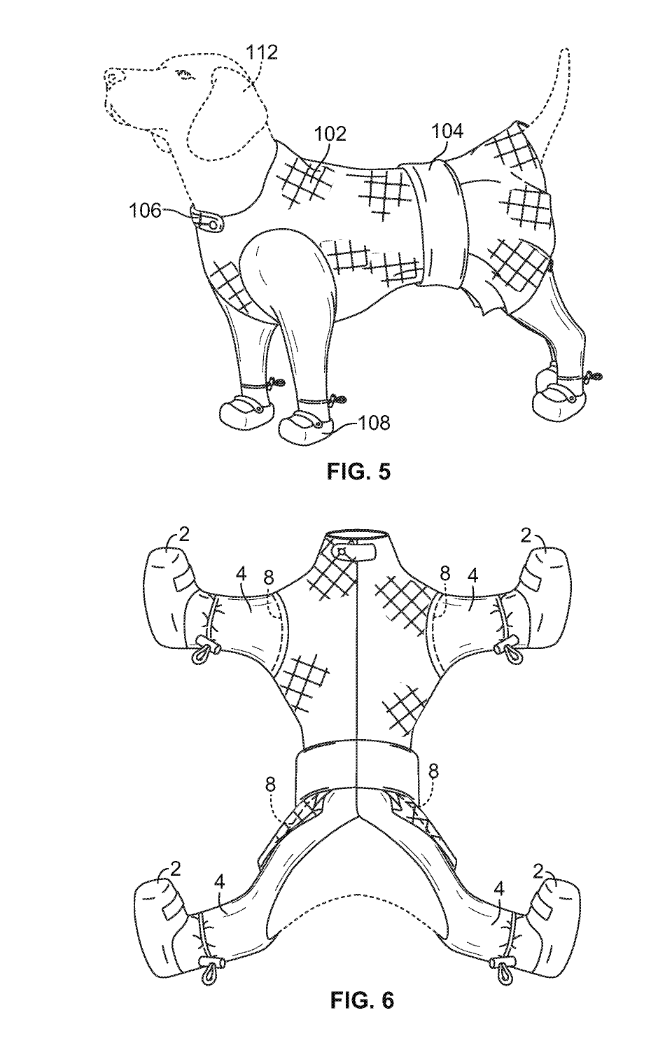

Referring to FIG. 2, a perspective illustration of the apparel 100 in FIG. 1 according to one embodiment of the invention. In one example, the apparel 100 may be designed or tailored to suit the sex of the animal 112. For example, as illustrated in FIG. 1 and FIG. 2, the apparel 100 includes a skirt or tapered design for a female dog. Furthermore, the apparel 100 may be tailored or styled for different climate, season, or fashion. For example, FIG. 5 illustrates a pet apparel 400 that is designed with fur-like materials with a matching set of leggings 408, a matching set of attachments 406 and 406 for the animal 112. As such, it is to be understood that the pet apparel 100, 200, 300, or 400 may be modified or styled to suit various needs of an owner of the animal 112 to outfit the animal 112 as she or he wishes without departing from the scope and spirit of the aspects of the invention.

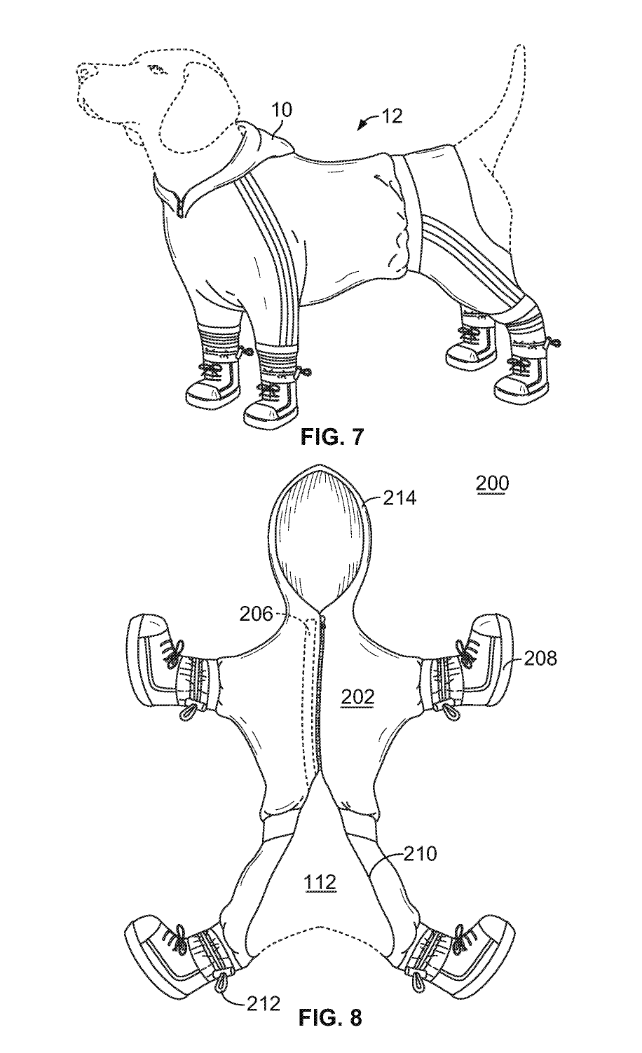

FIG. 6 further illustrates a perspective view of the fur-like trimmed apparel 400 according to one embodiment of the invention.

Moreover, FIG. 3 and FIG. 4 display embodiments of the apparel 200 and 300 where a hood is used as an embodiment of the invention.

It is also to be understood that a combination of materials may be used for the apparel 100, 200, 300 or 400. For example, the apparel 100, 200, 300 or 400 may include water resistant, water repellent, dirt repellent, or the like materials. In another embodiment, the materials for the apparel 100, 200, 300 or 400 may include a combination of materials, such as natural materials or synthetic materials. In a further example, the apparel 100, 200, 300, or 400 may be a coat, jacket, t-shirt, vest, dress, jogging suit, sweater, shirt, pants, or other suitable article of clothing made of a polyester like material. The material used may also be constructed with cotton, a cotton blend, a polyester blend, velour, polyurethane, etc. In one embodiment, a main garment may be created with or without a polyester lining. In this embodiment, the lining may also be cotton, a cotton blend, or a polyester blend. The underside opening provides ease of access for inserting the dog's legs into the set of leggings.

Also, prior art typically avoids covering the paws or claws of the animal 112 because of the dirt and also the tendencies of the animal 112 itself. As such, having any boots or mittens, etc., are purely afterthoughts. Aspects of the invention aim to overcome that by specifically having the set of leggings 108, 208, 308, or 408 to have an all-in-one design to integrate boots or mittens to receive and fit the paws or claws of the animal 112. In conjunction with this, embodiments of the invention further provide a cohesive styling or uniform look of the apparel 100, 200, 300 or 400. For example, the set of leggings 108, 208, 308 or 408 may have decorated styling sewed or coupled thereto. In another embodiment, the apparel 100, 200, 300, or 400 may include hidden seams connecting the set of leggings 108, 208, 308, or 408 to the torso element 102, 202, 302 or 402.

The inventor has created a stylish and unique solution to the problem pet owners face in trying to prevent the transmission of outside dirt and elements into the house when returning from walking their pets. Aspects of the invention provide full protection for the body, legs and paws without restricting the pets' natural movements as the main garment is attached to stretchable leggings with “feet” that are given the appearance of shoes. The parts are all connected together to create a one piece garment that looks as if there are three separate pieces. Since it is a one-piece instead of two or three separate pieces, it provides the owner with ease of dressing the pet, with no concern for separate pieces becoming lost or misplaced. The one piece garment offers protection for the pet's body, legs and paws. There is a rear opening that extends underneath the pets torso to provide potty ease for both male and female dogs. The all in one pet garment is intended for use with toy breeds and small to medium dog breeds. The garment may also be made in larger sizes for larger breeds of dogs.

In one embodiment, the set of leggings may be fixedly attached to the torso element 102 or main garment with hidden seams. For example, the set of leggings are both decorative and functional and also offer protection from dirt and inclement weather. The leggings may be constructed of a cotton/spandex/polyester blend, or may be made with lycra or other similar stretchable fabrics and integrated with water resistant fibers. The leggings are fixedly attached to the booties that protect the dogs' paws.

The bottom of the legging fabric is stitched around a sole or padding shaped to accommodate a dog's paw to create the bootie. The sole may also be constructed of man-made materials or rubber. The bootie may be attached with hidden seams to the leggings and may also be made from various waterproof man made materials. The set of leggings may have accoutrements on the outside of the set of leggings to create a more realistic appearance of an actual shoe. Accoutrements such as fur trim, laces, snaps, buckles, and zippers may help create the illusion of separate pieces.

In another example, a drawstring and clamp or other tying or restricting device may also be placed at the lower ends of the set of leggings. For example, the tying or restricting device may be disposed just above the ends to ensure that the paws remain in place within the set of leggings once the paws have been inserted. In this example, the drawstring may also be tightened and clamped to customize the fit of the ends of the set of leggings around the paw and lower leg.

It is further understood that coverings for the paws of pets that are integrated into their clothing so that the paw coverings are not lost or easily removed by the animal. A further embodiment of the invention is to enable a pet owner to dress their pet quickly and easily. Moreover, aspects of the invention provide outfits that are durable and machine washable.

Other additional objects and advantages of the invention will become apparent upon reading the following detailed description and upon reference to the drawing figures.

What is claimed is:

1. A pet apparel apparatus comprising:
a torso element for receiving a torso of an animal;
an opening for receiving a head of the animal;
a set of leggings, said set of leggings including materials for receiving legs of the animal and for receiving paws of the animal;
a set of attachments disposed on the torso element, said set of attachments having a male portion and a female portion, wherein the male portion corresponds to the female portion, wherein the set of attachments enclose the animal therein; and
another opening for receiving a rear of the animal.

2. The pet apparel apparatus according to claim 1, wherein the another opening comprises an opening for one or more of the following parts of the animal: croup, tail, rump, hip, and flank.

3. The pet apparel apparatus according to claim 1, further comprising a hood coupled to the torso element.

4. The pet apparel apparatus according to claim 1, wherein the torso element, the set of leggings, and the set of attachments are connected as an integrated piece.

5. The pet apparel apparatus according to claim 1, wherein the torso element and the set of leggings comprises being connected by hidden seams.

6. The pet apparel apparatus according to claim 1, further comprising a restricting device disposed on a lower end of the set of leggings.

7. The pet apparel apparatus according to claim 1, further comprising a sole disposed at each end of the set of leggings.

8. A pet garment apparatus comprising:
a torso element for receiving a torso of an animal;
an opening for receiving a head of the animal;
a hood disposed at the opening for covering the head of the animal;
a set of leggings, said set of leggings including materials for receiving legs of the animal and for receiving paws of the animal;
a set of fasteners disposed on the torso element, said set of fasteners having a male portion and a female portion, wherein the male portion corresponds to the female portion, wherein the set of fasteners enclose the animal therein; and
another opening for receiving a rear of the animal.

9. The pet garment apparatus according to claim 8, wherein the another opening comprises an opening for one or more of the following parts of the animal: croup, tail, rump, hip, and flank.

10. The pet apparel apparatus according to claim 8, wherein the torso element, the set of leggings, and the set of attachments are connected as an integrated piece.

11. The pet apparel apparatus according to claim 8, wherein the torso element and the set of leggings comprises being connected by hidden seams.

12. The pet apparel apparatus according to claim 8, further comprising a restricting device disposed on a lower end of the set of leggings.

13. The pet apparel apparatus according to claim 8, further comprising a sole disposed at each end of the set of leggings.

14. A pet apparel apparatus comprising:
a torso element for receiving a torso of an animal;
an opening for receiving a head of the animal;
a set of leggings, said set of leggings including materials for receiving legs of the animal and for receiving paws of the animal;
a set of attachments disposed on the torso element, said set of attachments having a male portion and a female portion, wherein the male portion corresponds to the female portion, wherein the set of attachments enclose the animal therein;
another opening for receiving a rear of the animal; and
wherein the torso element, the set of leggings, and the set of attachments are connected as an integrated piece.

15. The pet apparel apparatus according to claim 14, wherein the another opening comprises an opening for one or more of the following parts of the animal: croup, tail, rump, hip, and flank.

16. The pet apparel apparatus according to claim 14, further comprising a hood coupled to the torso element.

17. The pet apparel apparatus according to claim 14, further comprising a restricting device disposed on a lower end of the set of leggings.

18. The pet apparel apparatus according to claim 14, further comprising a sole disposed at each end of the set of leggings.
